(19) United States
(12) Patent Application Publication
(10) Pub. No.: US 2013/0144694 A1
(43) Pub. Date: Jun. 6, 2013

(54) DESIGNING VIRAL MARKETING STRATEGIES FOR UP-SELLING AND CROSS-SELLING

(71) Applicants: Amit A. Nanavati, New Delhi (IN); Ramasuri Narayanam, Bangalore (IN)

(72) Inventors: Amit A. Nanavati, New Delhi (IN); Ramasuri Narayanam, Bangalore (IN)

(73) Assignee: INTERNATIONAL BUSINESS MACHINES CORPORATION, Armonk, NY (US)

(21) Appl. No.: 13/312,511

(22) Filed: Dec. 6, 2011

(51) Int. Cl. G06Q 30/02

(52) U.S. Cl. 705/14.4

(57) ABSTRACT

Methods and arrangements for instituting a viral marketing strategy. Participants in a social network are ascertained. Mutual influence of the participants in purchasing decisions is determined, and purchasing influence of products on one another is assessed. At least one seed is selected from the participants for maximizing purchasing influence of one product on another product, based on mutual influence of the participants on one another.

### BACKGROUND

Generally, viral marketing has emerged as an effective tool for marketing in view of the increasing popularity of online social networks. Essentially, a main objective of viral marketing is to ascertain and leverage social interactions among individuals to promote awareness for products. In the face of limited advertising budgets, a key challenge then emerges in being able to select a set of influential individuals (or initial seeds) in the social network and provide them with discounts on products or even provide free samples, whereupon such individuals will then be in a position to raise and maximize awareness of a product over the social network. However, there is still significant room for improvement and innovation in making adequate use of social network relationships in promoting products.

### BRIEF SUMMARY

In summary, one aspect of the invention provides a method comprising: ascertaining participants in a social network; determining mutual influence of the participants in purchasing decisions; assessing purchasing influence of products on one another; and selecting at least one seed from the participants for maximizing purchasing influence of one product on another product, based on mutual influence of the participants on one another.

Another aspect of the invention provides an apparatus comprising: at least one processor; and a computer readable storage medium having computer readable program code embodied therewith and executable by the at least one processor, the computer readable program code comprising: computer readable program code configured to ascertain participants in a social network; computer readable program code configured to determine mutual influence of the participants in purchasing decisions; computer readable program code configured to assess purchasing influence of products on one another; and computer readable program code configured to select at least one seed from the participants for maximizing purchasing influence of one product on another product, based on mutual influence of the participants on one another.

An additional aspect of the invention provides a computer program product comprising: a computer readable storage medium having computer readable program code embodied therewith, the computer readable program code comprising: computer readable program code configured to ascertain participants in a social network; computer readable program code configured to determine mutual influence of the participants in purchasing decisions; computer readable program code configured to assess purchasing influence of products on one another; and computer readable program code configured to select at least one seed from the participants for maximizing purchasing influence of one product on another product, based on mutual influence of the participants on one another.

For a better understanding of exemplary embodiments of the invention, together with other and further features and advantages thereof, reference is made to the following description, taken in conjunction with the accompanying drawings, and the scope of the claimed embodiments of the invention will be pointed out in the appended claims.

### BRIEF DESCRIPTION OF THE SEVERAL VIEWS OF THE DRAWINGS

FIG. 1 schematically illustrates a general process overview for implementing seed selection in cross-sell and upsell viral marketing.

FIG. 2 sets forth details of a sample selling approximation algorithm for upsell.

FIG. 3 sets forth details of a sample selling approximation algorithm for a context of competitive products.

FIG. 4 sets forth a process more generally for instituting a viral marketing strategy.

FIG. 5 illustrates a computer system.

### DETAILED DESCRIPTION

It will be readily understood that the components of the embodiments of the invention, as generally described and illustrated in the figures herein, may be arranged and designed in a wide variety of different configurations in addition to the described exemplary embodiments. Thus, the following more detailed description of the embodiments of the invention, as represented in the figures, is not intended to limit the scope of the embodiments of the invention, as claimed, but is merely representative of exemplary embodiments of the invention.

Reference throughout this specification to “one embodiment” or “an embodiment” (or the like) means that a particular feature, structure, or characteristic described in connection with the embodiment is included in at least one embodiment of the invention. Thus, appearances of the phrases “in one embodiment” or “in an embodiment” or the like in various places throughout this specification are not necessarily all referring to the same embodiment.

Furthermore, the described features, structures, or characteristics may be combined in any suitable manner in at least one embodiment. In the following description, numerous specific details are provided to give a thorough understanding of embodiments of the invention. One skilled in the relevant art will recognize, however, that the various embodiments of the invention can be practiced without at least one of the specific details, or with other methods, components, materials, et cetera. In other instances, well-known structures, materials, or operations are not shown or described in detail to avoid obscuring aspects of the invention.

The description now turns to the figures. The illustrated embodiments of the invention will be best understood by reference to the figures. The following description is intended only by way of example and simply illustrates certain selected exemplary embodiments of the invention as claimed herein.

It should be noted that the flowchart and block diagrams in the figures illustrate the architecture, functionality, and operation of possible implementations of systems, apparatuses, methods and computer program products according to various embodiments of the invention. In this regard, each block in the flowchart or block diagrams may represent a module, segment, or portion of code, which comprises at least one executable instruction for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

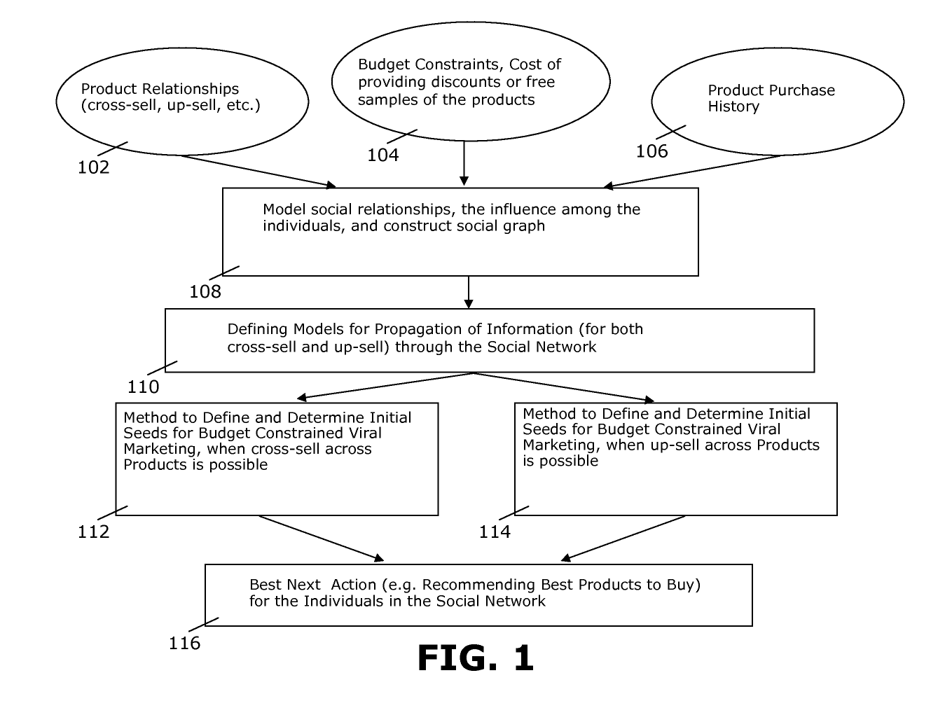

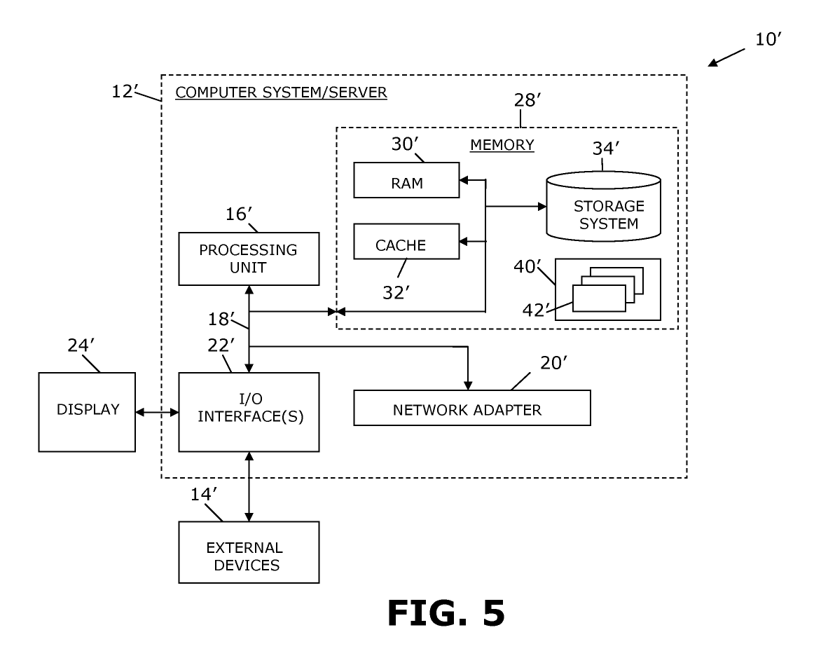

The disclosure now turns to FIGS. 1-3. It should be appreciated that the processes, arrangements and products broadly illustrated therein can be carried out on or in accordance with essentially any suitable computer system or set of computer systems, which may, by way of an illustrative and non-restrictive example, include a system or server such as that indicated at 12′ in FIG. 5. In accordance with an example embodiment, most if not all of the process steps, components and outputs discussed with respect to FIGS. 1-3 can be performed or utilized by way of a processing unit or units and system memory such as those indicated, respectively, at 16′ and 28′ in FIG. 5, whether on a server computer, a client computer, a node computer in a distributed network, or any combination thereof.

Often, individual companies design products or introduce services that end up leading to up-selling or cross-selling of such products, which can provide a significant return on an initial marketing investment if successful. In upselling, a sale is made where a purchased product exceeds the value of one initially offered (by the same or a different consumer) while in cross-selling the purchase of one product can influence the purchase of another (by the same or a different consumer). Accordingly, there are broadly contemplated herein, in accordance with at least one embodiment of the invention, methods and arrangements for facilitating viral marketing campaigns that lend themselves to significant cross-selling and/or up-selling.

In accordance with at least one embodiment of the invention, a general process overview is schematically illustrated in FIG. 1. Product relationships 102 are considered, e.g., whether two products compete with one another or somehow support one another. Other input parameters include budget constraints, which can include the cost of providing discounts or free samples of the products (104) and product purchase history (106) (i.e., history with respect to given consumers). There is then considered the viral effect of such multiple influences, involving people as well as products, and the influences are modeled. To this end, social relationships are modeled along with relative influence between individuals, whereupon a social graph can be constructed (108). Energy propagation models are constructed for determining the likelihood of cross-sell and up-sell of products. In other words, models are defined for the propagation of information, for both cross-sell and up-sell, through a social network (110). As such, a determination can be made as to those consumers who might best serve as initial seeds for virally propagating various products, while keeping in mind various product relationships. To this end, single or parallel steps can be executed for cross-sell (112) and/or up-sell (114), as needed or appropriate. This may be followed by a determination of a best next step (116), e.g., recommending to individuals in the social network at least one product for purchase.

In accordance with at least one embodiment of the invention, let G=(V, E) represent a social network of buyers where V represents the set of buyers and E represents the social connections (or contacts) among these buyers. Let |V|=n and |E|=m. Let X and Y then represent two products such that Y is costlier, and considered to be better than, X such that Y can replace X in an up-sell. Further, let it be assumed that the purchase patterns of Y can influence those of X, such that a cross-sell is possible.

In accordance with at least one embodiment of the invention, let it be assumed that a buyer who buys the product Y does not buy X and, further that the company has a budget B for viral marketing, including an allowance for providing free samples of products to initial seed members. Assume, for the present example, then, that: a free sample of product X incurs a cost of cx; a free sample of product Y incurs a cost of cy; and the cost for promoting up-sell to the company is thus cxy. Also, assume that when an item of product X is sold, it results in a benefit bx to the company and when an item of product Y is sold, it results in a benefit by to the company. Accordingly, if an individual has already bought product X and then is chosen or promoted to buy product Y, then it incurs a cost of cxy to the company. Each upsell results in a benefit of (by−bx) to the company. It is reasonable to assume that cx<bx, cy<by, cxy<=cy.

Accordingly, in accordance with at least one embodiment of the invention, given the budget B, a problem can be framed in terms of choosing a set of influential seed members for product X, choosing product Y, and aiming to upsell from X to Y such that the influence of these seed members is maximized over the network and hence the revenue of the company is also maximized. A linear threshold model with substitute products is thus broadly contemplated, and will be appreciated in more detail herebelow.

In accordance with at least one embodiment of the invention, for an up-sell model, assume again that Y is a costlier and better version of X. Then let it be assumed that a person P is influenced about X and Y based on how many neighbors (i.e., people defined as being close or neighboring in a social network) have bought X and Y. If P already possesses X, then he/she is influenced about Y based on how many neighbors have upgraded from X to Y.

In accordance with at least one embodiment of the invention, a similar model is broadly contemplated for cross-sell as well. A difference, however, is that in the case of cross-sell, products can co-exist, that is, can be bought as a result of each other or one-way. There may be a precedence relation (e.g., computer before printer) or co-existence (e.g., cap and cooling glasses). This is modeled by setting the appropriate thresholds for a product if the other is already there, and on the neighborhoods

In accordance with at least one embodiment of the invention, selling approximation algorithms for up-sell and cross-sell problems as just described; the algorithms are described in more detail herebelow. As such, an approximation ratio can be assumed to be independent of the number of seeds chosen and the size of the social network. Moreover, the approximation ratio depends only on the values of cx, cy, and cxy and the budget B.

In a selling approximation algorithm, in accordance with at least one embodiment of the invention, each node in V is marked as unused. Then, the following steps are repeated until the budget B is exhausted. Pick an unused node v1 in V such that it maximizes the ratio (referred to as valx) of the net increase in the revenue to the cost cx, when given a free sample of product X. Pick an unused node v2 in V such that it maximizes the ratio (referred to as valy) of the net increase in the revenue to the cost cy, when given a free sample of product Y. From the set of all nodes with product X, and a node v3 with maximum value for the ratio of the net increase in the revenue to the cost cxy, this value is referred to as valxy. If valx is greater than valy and valxy, then add node v1 to the set of seeds for product X and mark it used. If valy is greater than valx and valxy, then add node v2 to the set of seeds for product Y and mark it used. If valxy is greater than valx and valy, then add node v3 to the set of seeds for upsell from X to Y.

Inasmuch as the selling approximation algorithm set forth hereinabove provides a basis for selecting seeds for upsell and cross-sell, two variant algorithms are broadly contemplated herein, in accordance with at least one embodiment of the invention, by way of maximizing different parameters. The two variant algorithms can be employed for faster running time in practice; solutions therefrom will at least usually provide a reasonable approximation of solutions obtained from the selling algorithm set forth hereinabove. It is further to be appreciated that the two variant algorithms are applicable for selecting seeds in either upsell or cross-sell contexts.

Thus, in a first variant algorithm in accordance with at least one embodiment of the invention, and which is a maximum degree based heuristic algorithm, nodes (or individuals) with more connections over the social network are targeted for selection as seeds. First, nodes are sorted in decreasing order of their number of links (or contacts) in the social network. The following steps are then repeated until the budget B is exhausted. Take the node v1 from the top of the sorted list. If a free sample of product X (or Y) is given to this node, let valx (or valy) be the value of the ratio of the net increase in the revenue to the cost cx (or cy). From the set of all nodes with product X, and a node v2 with maximum value for the ratio of the net increase in the revenue to the cost cxy, refer to this value as valxy. If valx is greater than valy and valxy, then add node v1 to the set of seeds for product X and remove it from the sorted list. If valy is greater than valx and valxy, then add node v1 to the set of seeds for product Y and remove it from the sorted list. If valxy is greater than valx and valy, then add node v2 to the set of seeds for upsell from X to Y.

In a second variant algorithm in accordance with at least one embodiment of the invention, which is a maximum influence based heuristic algorithm, nodes (or individuals) with high influence over neighbors in networks are targeted for selection as seeds. For each node, the sum of influence (call it cumulative influence) of that node on each its neighbors is computed. Then, the nodes are sorted in decreasing order of their cumulative influence. The following steps are then repeated until the budget B is exhausted. Take the node v1 from the top of the sorted list. If a free sample of product X (or Y) is given to this node, let valx (or valy) be the value of the ratio of the net increase in the revenue to the cost cx (or cy). From the set of all nodes with product X, find a node v2 with maximum value for the ratio of the net increase in the revenue to the cost cxy, referring to this value as valxy. If valx is greater than valy and valxy, then add node v1 to the set of seeds for product X and remove it from the sorted list. If valy is greater than valx and valxy, then add node v1 to the set of seeds for product Y and remove it from the sorted list. If valxy is greater than valx and valy, then add node v2 to the set of seeds for upsell from X to Y.

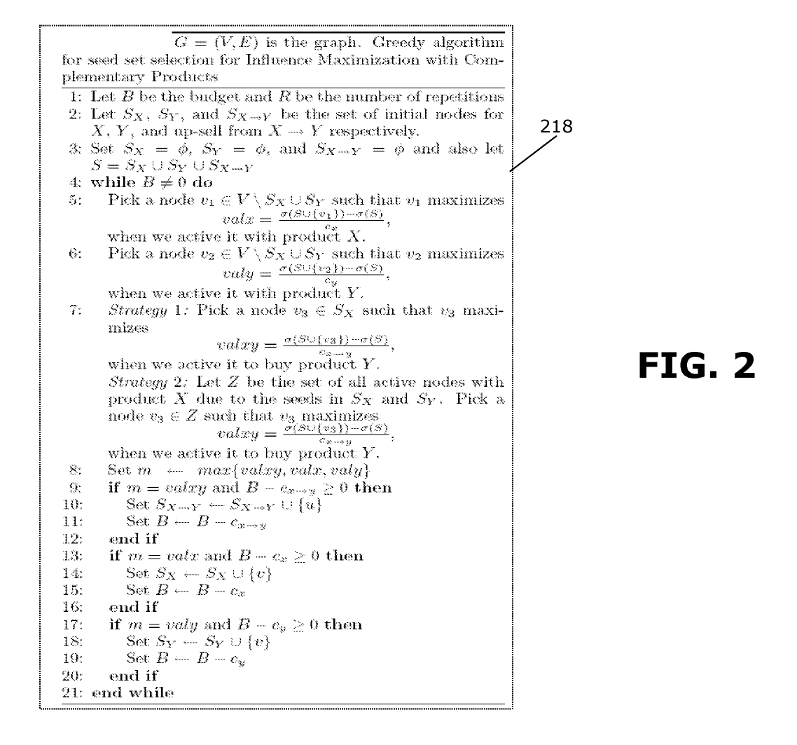

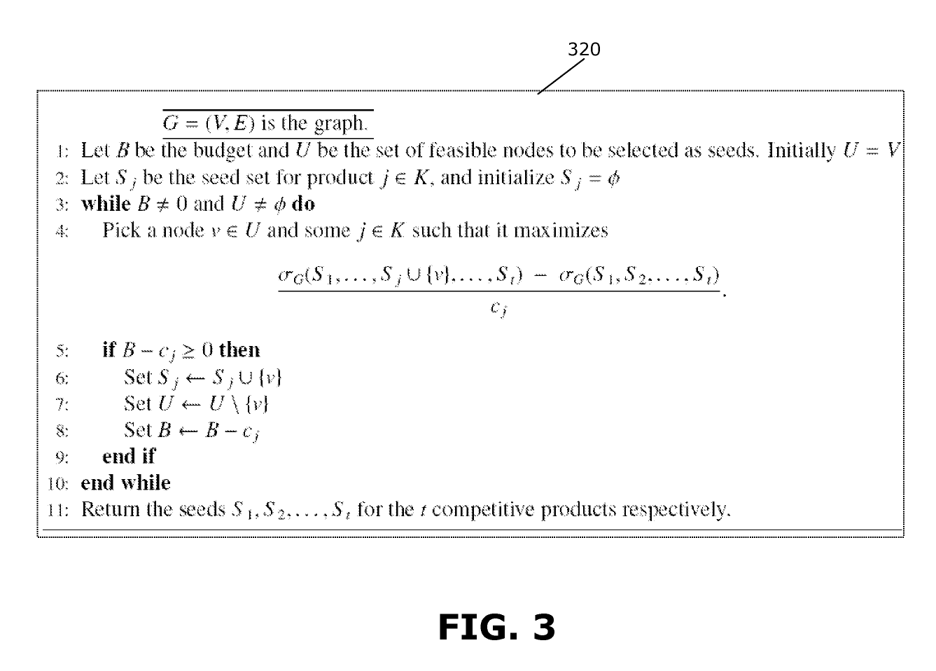

FIG. 2 sets forth details of a sample selling approximation algorithm 218 for up-sell, while FIG. 3 sets forth details of a sample selling approximation algorithm 320 for a context of competitive products, which itself can be viewed as a variation for both the cross-sell and upsell contexts.

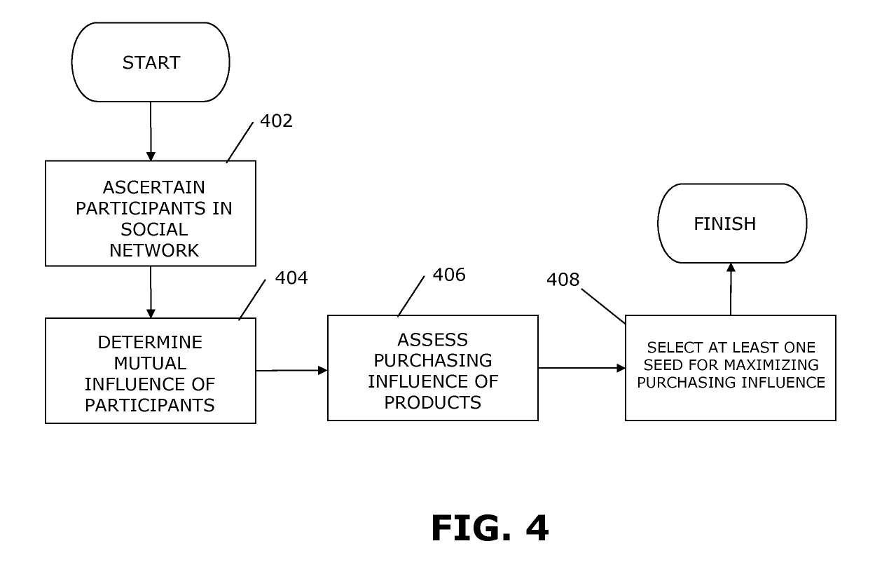

FIG. 4 sets forth a process more generally for instituting a marketing strategy for cross-sell or upsell, in accordance with at least one embodiment of the invention. It should be appreciated that a process such as that broadly illustrated in FIG. 4 can be carried out on essentially any suitable computer system or set of computer systems, which may, by way of an illustrative and on-restrictive example, include a system such as that indicated at 12′ in FIG. 5. In accordance with an example embodiment, most if not all of the process steps discussed with respect to FIG. 4 can be performed by way a processing unit or units and system memory such as those indicated, respectively, at 16′ and 28′ in FIG. 5.

As shown in FIG. 4, participants in a social network are ascertained (402). Mutual influence of the participants in purchasing decisions is determined (404), and purchasing influence of products on one another is assessed (406). At least one seed is selected from the participants for maximizing purchasing influence of one product on another product, based on mutual influence of the participants on one another (408).

Referring now to FIG. 5, a schematic of an example of a cloud computing node is shown. Cloud computing node 10′ is only one example of a suitable cloud computing node and is not intended to suggest any limitation as to the scope of use or functionality of embodiments of the invention described herein. Regardless, cloud computing node 10′ is capable of being implemented and/or performing any of the functionality set forth hereinabove. In accordance with embodiments of the invention, computing node 10′ may not necessarily even be part of a cloud network but instead could be part of another type of distributed or other network, or could represent a stand-alone node. For the purposes of discussion and illustration, however, node 10′ is variously referred to herein as a “cloud computing node”.

In cloud computing node 10′ there is a computer system/server 12′, which is operational with numerous other general purpose or special purpose computing system environments or configurations. Examples of well-known computing systems, environments, and/or configurations that may be suitable for use with computer system/server 12′ include, but are not limited to, personal computer systems, server computer systems, thin clients, thick clients, hand-held or laptop devices, multiprocessor systems, microprocessor-based systems, set top boxes, programmable consumer electronics, network PCs, minicomputer systems, mainframe computer systems, and distributed cloud computing environments that include any of the above systems or devices, and the like.

Computer system/server 12′ may be described in the general context of computer system-executable instructions, such as program modules, being executed by a computer system. Generally, program modules may include routines, programs, objects, components, logic, data structures, and so on that perform particular tasks or implement particular abstract data types. Computer system/server 12′ may be practiced in distributed cloud computing environments where tasks are performed by remote processing devices that are linked through a communications network. In a distributed cloud computing environment, program modules may be located in both local and remote computer system storage media including memory storage devices.

As shown in FIG. 5, computer system/server 12′ in cloud computing node 10 is shown in the form of a general-purpose computing device. The components of computer system/server 12′ may include, but are not limited to, at least one processor or processing unit 16′, a system memory 28′, and a bus 18′ that couples various system components including system memory 28′ to processor 16′.

Bus 18′ represents at least one of any of several types of bus structures, including a memory bus or memory controller, a peripheral bus, an accelerated graphics port, and a processor or local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnects (PCI) bus.

Computer system/server 12′ typically includes a variety of computer system readable media. Such media may be any available media that is accessible by computer system/server 12′, and it includes both volatile and non-volatile media, removable and non-removable media.

System memory 28′ can include computer system readable media in the form of volatile memory, such as random access memory (RAM) 30′ and/or cache memory 32′. Computer system/server 12′ may further include other removable/non-removable, volatile/non-volatile computer system storage media. By way of example only, storage system 34′ can be provided for reading from and writing to a non-removable, non-volatile magnetic media (not shown and typically called a “hard drive”). Although not shown, a magnetic disk drive for reading from and writing to a removable, non-volatile magnetic disk (e.g., a “floppy disk”), and an optical disk drive for reading from or writing to a removable, non-volatile optical disk such as a CD-ROM, DVD-ROM or other optical media can be provided. In such instances, each can be connected to bus 18′ by at least one data media interface. As will be further depicted and described below, memory 28′ may include at least one program product having a set (e.g., at least one) of program modules that are configured to carry out the functions of embodiments of the invention.

Program/utility 40′, having a set (at least one) of program modules 42′, may be stored in memory 28′ by way of example, and not limitation, as well as an operating system, at least one application program, other program modules, and program data. Each of the operating system, at least one application program, other program modules, and program data or some combination thereof, may include an implementation of a networking environment. Program modules 42′ generally carry out the functions and/or methodologies of embodiments of the invention as described herein.

Computer system/server 12′ may also communicate with at least one external device 14′ such as a keyboard, a pointing device, a display 24′, etc.; at least one device that enable a user to interact with computer system/server 12; and/or any devices (e.g., network card, modem, etc.) that enable computer system/server 12′ to communicate with at least one other computing device. Such communication can occur via I/O interfaces 22′. Still yet, computer system/server 12′ can communicate with at least one network such as a local area network (LAN), a general wide area network (WAN), and/or a public network (e.g., the Internet) via network adapter 20′. As depicted, network adapter 20′ communicates with the other components of computer system/server 12′ via bus 18′. It should be understood that although not shown, other hardware and/or software components could be used in conjunction with computer system/server 12′. Examples, include, but are not limited to: microcode, device drivers, redundant processing units, external disk drive arrays, RAID systems, tape drives, and data archival storage systems, etc.

It should be noted that aspects of the invention may be embodied as a system, method or computer program product. Accordingly, aspects of the invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the invention may take the form of a computer program product embodied in at least one computer readable medium having computer readable program code embodied thereon.

Any combination of at least one computer readable medium may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having at least one wire, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium may be transmitted using any appropriate medium, including but not limited to wireless, wire line, optical fiber cable, RF, etc., or any suitable combination of the foregoing.

Computer program code for carrying out operations for aspects of the invention may be written in any combination of at least one programming language, including an object oriented programming language such as Java®, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This disclosure has been presented for purposes of illustration and description but is not intended to be exhaustive or limiting. Many modifications and variations will be apparent to those of ordinary skill in the art. The embodiments were chosen and described in order to explain principles and practical application, and to enable others of ordinary skill in the art to understand the disclosure for various embodiments with various modifications as are suited to the particular use contemplated.

Although illustrative embodiments of the invention have been described herein with reference to the accompanying drawings, it is to be understood that the embodiments of the invention are not limited to those precise embodiments, and that various other changes and modifications may be affected therein by one skilled in the art without departing from the scope or spirit of the disclosure.

1.-12. (canceled)

13. An apparatus comprising:
at least one processor; and
a computer readable storage medium having computer readable program code embodied therewith and executable by the at least one processor, the computer readable program code comprising:
computer readable program code configured to ascertain participants in a social network;
computer readable program code configured to determine mutual influence of the participants in purchasing decisions;
computer readable program code configured to assess purchasing influence of products on one another; and
computer readable program code configured to select at least one seed from the participants for maximizing purchasing influence of one product on another product, based on mutual influence of the participants on one another.

14. A computer program product comprising:
a computer readable storage medium having computer readable program code embodied therewith, the computer readable program code comprising:
computer readable program code configured to ascertain participants in a social network;
computer readable program code configured to determine mutual influence of the participants in purchasing decisions;
computer readable program code configured to assess purchasing influence of products on one another; and
computer readable program code configured to select at least one seed from the participants for maximizing purchasing influence of one product on another product, based on mutual influence of the participants on one another.

15. The computer program product according to claim 14, wherein said computer readable program code is configured to assess a supportive influence of one product on another product.

16. The computer program product according to claim 14, wherein said computer readable program code is configured to assess a competitive relationship between one product and another product.

17. The computer program product according to claim 14, wherein said computer readable program code is configured to select at least one seed for maximizing upsell potential of a product purchase by the at least one seed.

18. The computer program product according to claim 17, wherein said computer readable program code is configured to select at least one seed via employing a selling approximation algorithm.

19. The computer program product according to claim 14, wherein said wherein said computer readable program code is configured to select at least one seed for maximizing cross-sell potential of a product purchase by the at least one seed.

20. The computer program product according to claim 19, wherein said computer readable program code is configured to select at least one seed via employing a selling approximation algorithm.

21. The computer program product according to claim 14, wherein said computer readable program code is configured to select at least one seed via employing a selling approximation algorithm.

22. The computer program product according to claim 21, wherein said computer readable program code is configured to select at least one seed via employing variables of: cost of providing a free sample of a first product to a seed, cost of providing a free sample of a second product to a seed.

23. The computer program product according to claim 14, wherein said computer readable program code is configured to select at least one seed via employing a maximum degree based heuristic algorithm.

24. The computer program product according to claim 14, wherein said computer readable program code is configured to select at least one seed via employing a maximum influence based heuristic algorithm.

25. The computer program product according to claim 14, wherein said computer readable program code is configured to select at least one seed via employing variables of: cost of providing a free sample of a first product to a seed, cost of providing a free sample of a second product to a seed.
